(19) United States
(12) Patent Application Publication
(10) Pub. No.: US 2006/0175726 A1
(43) Pub. Date: Aug. 10, 2006

(54) Method of forming liquid ejection orifice

(75) Inventor: Yasuhiko Kachi, Kanagawa (JP)

Correspondence Address: BIRCH STEWART KOLASCH & BIRCH, PO BOX 747, FALLS CHURCH, VA, 22040-0747, US

(73) Assignee: FUJI PHOTO FILM CO., LTD.

(21) Appl. No.: 11/344,225

(22) Filed: Feb. 1, 2006

(30) Foreign Application Priority Data
Feb. 4, 2005 (JP) 2005-029568

(51) Int. Cl. B29C 45/00

(52) U.S. Cl. 264/161; 264/328.1

(57) ABSTRACT

The method forms a plate having liquid ejection orifices from a thermosetting resin containing inorganic micro-particles. The method comprises the steps of: opposing a first mold having pins for forming the liquid ejection orifices and a second mold such that a clearance of δ is provided between the second mold and each of tips of the pins, the clearance δ and a diameter d of the inorganic micro-particles having a relationship of δ<d; and injecting the thermosetting resin containing the inorganic micro-particles into a cavity between the first and second molds for forming the plate.

### BACKGROUND OF THE INVENTION

1. Field of the Invention

The present invention relates to a method for forming liquid ejection orifice, and more particularly to a method for forming liquid ejection orifice whereby fine liquid ejection orifices are formed by resin molding.

2. Description of the Related Art

An inkjet recording apparatus (inkjet printer) is known as an image forming apparatus. The inkjet recording apparatus includes a liquid ejection head or an inkjet head having an arrangement of a plurality of ejection orifices or nozzles for ejecting liquid or ink, and forms images on a recording medium by ejecting ink from the nozzles while causing the inkjet head and the recording medium to move relatively to each other.

Various methods are known as ink ejection methods for inkjet recording apparatuses. For example, a piezoelectric method is known, in which a diaphragm constituting a portion of the pressure chamber is deformed by the deformation of a piezoelectric element, thereby changing the volume of the pressure chamber. The ink is introduced into the pressure chamber from an ink supply passage when the volume of the pressure chamber is increased, and the ink inside the pressure chamber is ejected from the nozzle in the form of droplets when the volume of the pressure chamber is decreased.

In an inkjet recording apparatus of this kind, in order to form images of higher quality, the nozzle diameter is reduced, thereby reducing the size of the ink droplets ejected from the nozzles, and furthermore, the nozzles are arranged at high density so as to increase the number of pixels per image.

Therefore, a large number of very fine nozzles or ejection orifices are formed in the nozzle plate. A resin molding method has been proposed as a method for forming fine orifices or nozzles efficiently to a high degree of accuracy by using a resin material having excellent processibility and excellent ink tolerance.

Japanese Patent Application Publication No. 2000-309099 discloses a method in which a resin sheet is used as an inserting member in an orifice plate part, and ink flow channels, ink chambers and ink supply ports are integrally formed by injection molding of a filling resin, thereby making it possible to form nozzles with good accuracy, by laser processing, or the like.

Japanese Patent Application Publication No. 2002-331668 discloses that a first base body including flow channel grooves and the ejection orifice peripheral parts of an orifice plate, and a second base body including the ejection orifice circumferential parts of the orifice plate, liquid chambers and liquid supply ports, are integrated by coinjection molding. The first base body is made from a pure material, polysulfone in particular, which can be molded very intricately, while the second base body is made from a composite material filled with a filler such as beads, thereby obtaining good strength. Due to the combination of the increased molding accuracy provided by the first base body and the increased rigidity provided by the second base body, very fine secondary processing of nozzles, and the like, can be performed readily.

International Application Publication No. WO 02/02697 discloses a method in which an inkjet ejection device is formed integrally from a thermosetting resin composition containing 95 wt % to 35 wt % thermosetting resin such as epoxy resin or phenol resin, and 5 wt % to 65 wt % organic filler, such as unsaturated polyester or phenol resin having a particle diameter of 10 μm or smaller. The thermosetting resin and the organic micro-particles are made to have substantially the same laser absorption wavelength, and the thin film of burrs in the nozzle forming parts are treated in a secondary step by laser. The clearance of the nozzle forming molds is made smaller than the size of the organic particles. The processing characteristics are thus improved.

However, in the method described in Japanese Patent Application Publication No. 2000-309099, there is a problem in that the number of complicated tasks, such as setting the resin sheet on the resin forming molds in order to form the insert, is increased, and productivity hence declines. In the method described in Japanese Patent Application Publication No. 2002-331668, due to the coinjection molding process, the number of resin filling steps increases, and productivity hence declines.

Moreover, in the method described in International Application Publication No. WO 02/02697, if the thermosetting resin molding containing 95 wt % to 35 wt % thermosetting resin and 5 wt % to 65 wt % organic filler having the particle diameter of 10 μm or smaller is used as the structural body of the ejection device, then there is a problem in that sufficient hardness is not obtained in the pressure chambers, and the method is not suitable for the ejection device for high-viscosity ink, in particular. Furthermore, there is a problem in that the method is not suitable for forming a large number of nozzles, since the method involves the nozzle forming step using laser.

### SUMMARY OF THE INVENTION

The present invention has been contrived in view of the foregoing circumstances, an object thereof being to provide a liquid ejection orifice forming method whereby the strength of the structural body can be improved when forming very fine liquid ejection orifices by means of resin molding, and furthermore, whereby burr in the parts forming the liquid ejection orifices (nozzles) can be removed readily and simultaneous processing of a plurality of nozzles can be performed.

In order to attain the aforementioned object, the present invention is directed to a method of forming a plate having liquid ejection orifices from a thermosetting resin containing inorganic micro-particles, the method comprising the steps of: opposing a first mold having pins for forming the liquid ejection orifices and a second mold such that a clearance of δ is provided between the second mold and each of tips of the pins, the clearance δ and a diameter d of the inorganic micro-particles having a relationship of δ<d; and injecting the thermosetting resin containing the inorganic micro-particles into a cavity between the first and second molds for forming the plate.

Accordingly, the inorganic micro-particles do not enter into the clearance between the pins of the first mold for forming the liquid ejection orifices and the second mold opposing the first mold, and the thin film of burr of the thermosetting resin formed at the liquid ejection orifice forming parts does not contain the inorganic micro-particles. Therefore, the thin film of burr can be removed readily by mechanical processing in a subsequent step, and furthermore, since the structural body or the plate in which the liquid ejection orifices are formed contains the inorganic micro-particles, then it is possible to improve the strength of the structural body in the regions apart from the liquid ejection orifice forming parts.

Preferably, the inorganic micro-particles have a Young's modulus of not less than 50 GPa and a coefficient of linear expansion of not more than 5×10⁻⁶/° C. Accordingly, it is possible to obtain a coefficient of linear expansion of the molded resin similar to that of metal, such as stainless steel, for example, and distortion or warping due to differences in coefficient of linear expansion is prevented in cases where the resin material (nozzle plate) containing the inorganic micro-particles is combined with a metal (a plate-shaped member forming a portion of the pressure chambers).

Preferably, the method further comprises the step of removing a thin film of burr of the thermosetting resin having been formed on the plate correspondingly to the clearance, by a process of blowing one of fluid and micro-particles. Accordingly, it is possible to remove the thin film of burr, readily.

Preferably, the second mold has recess parts corresponding to the pins of the first mold such that a thin film of burr of the thermosetting resin having a projecting shape is formed on a surface of the plate correspondingly to the clearance between the pins of the first mold and the recess parts of the second mold. Accordingly, the thin film of burr can be removed readily by mechanical processing, and a large number of liquid ejection orifices can be processed simultaneously.

Preferably, the method further comprises the step of cutting the thin film of burr having the projecting shape at a position distanced from the surface of the plate for forming an edge of each of the liquid ejection orifices. Accordingly, processing of high-quality edge parts at the liquid ejection orifices becomes possible, and since the edges of the liquid ejection orifices do not lie in the same plane as the surface on which the liquid ejection orifices are formed, then there is little soiling of the surface by liquid, and maintenance characteristics are improved.

As described above, according to the method of forming liquid ejection orifices according to the present invention, inorganic micro-particles do not enter into the clearance space between the pins of the mold of the liquid ejection orifice forming parts and the mold opposing same, and hence the thin film of burr of the thermosetting resin formed at the liquid ejection orifice forming parts does not contain the inorganic micro-particles. Therefore, the thin film of burr can be removed readily by mechanical processing in a subsequent process, while at the same time, the inorganic micro-particles can be incorporated into the structural body in which the liquid ejection orifices are formed, thereby making it possible to improve the strength of the structural body in the regions apart from the liquid ejection orifice forming parts.

### BRIEF DESCRIPTION OF THE DRAWINGS

The nature of this invention, as well as other objects and advantages thereof, will be explained in the following with reference to the accompanying drawings, in which like reference characters designate the same or similar parts throughout the figures and wherein:

FIG. 1 is a general schematic drawing of an inkjet recording apparatus having liquid ejection orifices formed by a method of forming liquid ejection orifices according to an embodiment of the present invention;

FIG. 2 is a plan view of the principal part around a print unit in the inkjet recording apparatus in FIG. 1;

FIG. 3 is a plan perspective diagram showing an embodiment of the structure of a print head;

FIG. 4 is a cross-sectional diagram along line 4-4 in FIG. 3;

FIG. 5 is a schematic drawing showing the composition of an ink supply system in the inkjet recording apparatus;

FIG. 6 is a partial block diagram showing the system composition of the inkjet recording apparatus;

FIGS. 7A to 7D are illustrative diagrams for explaining a method of forming a fine structure by means of general resin molding;

FIG. 8 is an illustrative diagram for explaining a nozzle forming method (method of forming liquid ejection orifice) according to an embodiment of the present invention;

FIGS. 9A to 9C are illustrative diagrams for explaining a method of forming a nozzle plate according to a first embodiment of the invention;

FIG. 10 is an illustrative diagram for explaining a nozzle forming method (method of forming liquid ejection orifice) according to a second embodiment of the present invention; and

FIGS. 11A and 11B are illustrative diagrams for explaining the method of forming the nozzle plate according to the second embodiment of the invention.

### DETAILED DESCRIPTION OF THE PREFERRED EMBODIMENTS

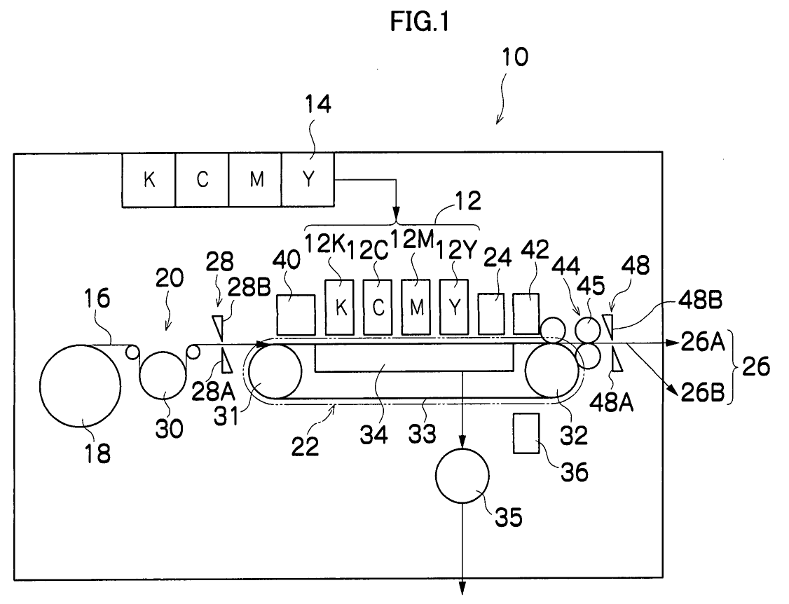

FIG. 1 is a general schematic drawing showing an overview of an embodiment of an inkjet recording apparatus as an image forming apparatus having liquid ejection orifices or liquid ejection nozzles (hereinafter referred to as simply “nozzles”) formed by a method of forming liquid ejection orifice according to an embodiment of the present invention.

As shown in FIG. 1, the inkjet recording apparatus 10 comprises: a printing unit 12 having a plurality of print heads (liquid ejection heads) 12K, 12C, 12M, and 12Y for ink colors of black (K), cyan (C), magenta (M), and yellow (Y), respectively; an ink storing and loading unit 14 for storing inks of K, C, M and Y to be supplied to the print heads 12K, 12C, 12M, and 12Y; a paper supply unit 18 for supplying recording paper 16; a decurling unit 20 for removing curl in the recording paper 16; a belt conveyance unit 22 disposed facing the nozzle face (ink-droplet ejection face) of the print unit 12, for conveying the recording paper 16 while keeping the recording paper 16 flat; a print determination unit 24 for reading the printed result produced by the printing unit 12; and a paper output unit 26 for outputting image-printed recording paper (printed matter) to the exterior.

In FIG. 1, a magazine for rolled paper (continuous paper) is shown as an embodiment of the paper supply unit 18; however, more magazines with paper differences such as paper width and quality may be jointly provided. Moreover, papers may be supplied with cassettes that contain cut papers loaded in layers and that are used jointly or in lieu of the magazine for rolled paper.

In the case of a configuration in which roll paper is used, a cutter 28 is provided as shown in FIG. 1, and the roll paper is cut to a desired size by the cutter 28. The cutter 28 has a stationary blade 28A, of which length is not less than the width of the conveyor pathway of the recording paper 16, and a round blade 28B, which moves along the stationary blade 28A. The stationary blade 28A is disposed on the reverse side of the printed surface of the recording paper 16, and the round blade 28B is disposed on the printed surface side across the conveyance path. When cut paper is used, the cutter 28 is not required.

In the case of a configuration in which a plurality of types of recording paper can be used, it is preferable that an information recording medium such as a bar code and a wireless tag containing information about the type of paper is attached to the magazine, and by reading the information contained in the information recording medium with a predetermined reading device, the type of paper to be used is automatically determined, and ink-droplet ejection is controlled so that the ink-droplets are ejected in an appropriate manner in accordance with the type of paper.

The recording paper 16 delivered from the paper supply unit 18 retains curl due to having been loaded in the magazine. In order to remove the curl, heat is applied to the recording paper 16 in the decurling unit 20 by a heating drum 30 in the direction opposite from the curl direction in the magazine. The heating temperature at this time is preferably controlled so that the recording paper 16 has a curl in which the surface on which the print is to be made is slightly round outward.

The decurled and cut recording paper 16 is delivered to the belt conveyance unit 22. The belt conveyance unit 22 has a configuration in which an endless belt 33 is set around rollers 31 and 32 so that the portion of the endless belt 33 facing at least the nozzle face of the printing unit 12 and the sensor face of the print determination unit 24 forms a flat plane.

There are no particular limitations on the structure of the belt conveyance unit 22, and it may use vacuum suction conveyance in which the recording paper 16 is conveyed by being suctioned onto the belt 33 by negative pressure created by suctioning air through suction apertures provided on the belt surface, or it may be based on electrostatic attraction.

The belt 33 has the width broader than the width of the recording paper 16, and in the case of the vacuum suction conveyance method described above, a plurality of suction apertures (not shown) are formed in the surface of the belt 33. A suction chamber 34 is disposed in a position facing the sensor surface of the print determination unit 24 and the nozzle surface of the printing unit 12 on the interior side of the belt 33, which is set around the rollers 31 and 32, as shown in FIG. 1; and the suction chamber 34 provides suction with a fan 35 to generate a negative pressure, thereby holding the recording paper 16 onto the belt 33 by suction.

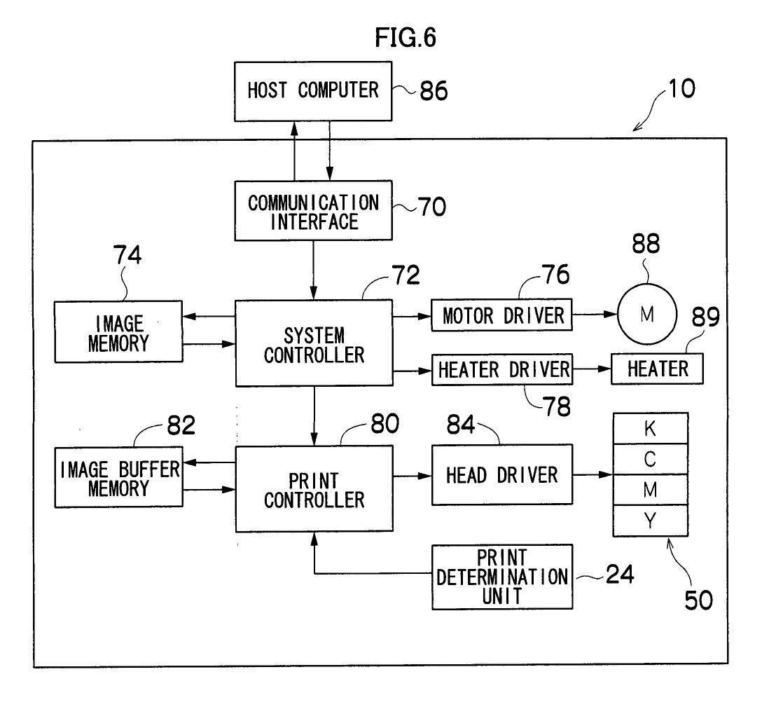

The belt 33 is driven in the clockwise direction in FIG. 1 by the motive force of a motor 88 (not shown in FIG. 1, but shown in FIG. 6) being transmitted to at least one of the rollers 31 and 32, which the belt 33 is set around, and the recording paper 16 held on the belt 33 is conveyed from left to right in FIG. 1.

Since ink adheres to the belt 33 when a marginless print job or the like is performed, a belt-cleaning unit 36 is disposed in a predetermined position (a suitable position outside the printing area) on the exterior side of the belt 33. Although the details of the configuration of the belt-cleaning unit 36 are not shown, embodiments thereof include a configuration in which the belt 33 is nipped with cleaning rollers such as a brush roller and a water absorbent roller, an air blow configuration in which clean air is blown onto the belt 33, or a combination of these. In the case of the configuration in which the belt 33 is nipped with the cleaning rollers, it is preferable to make the line velocity of the cleaning rollers different than that of the belt 33 to improve the cleaning effect.

The inkjet recording apparatus 10 can comprise a roller nip conveyance mechanism, in which the recording paper 16 is pinched and conveyed with nip rollers, instead of the belt conveyance unit 22. However, there is a drawback in the roller nip conveyance mechanism that the print tends to be smeared when the printing area is conveyed by the roller nip action because the nip roller makes contact with the printed surface of the paper immediately after printing. Therefore, the suction belt conveyance in which nothing comes into contact with the image surface in the printing area is preferable.

A heating fan 40 is disposed on the upstream side of the printing unit 12 in the conveyance pathway formed by the belt conveyance unit 22. The heating fan 40 blows heated air onto the recording paper 16 to heat the recording paper 16 immediately before printing so that the ink deposited on the recording paper 16 dries more easily.

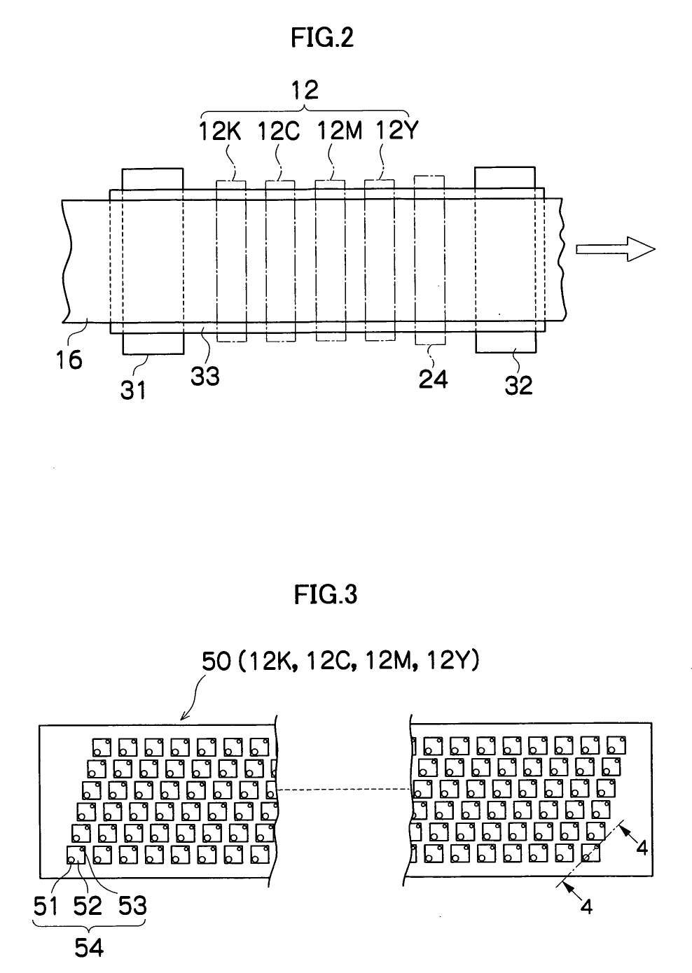

FIG. 2 is a principal plan diagram showing the periphery of the print unit 12 in the inkjet recording apparatus 10.

As shown in FIG. 2, the print unit 12 includes so-called “full line heads” in which line heads having a length corresponding to the maximum paper width are arranged in a direction (main scanning direction) that is perpendicular to the paper conveyance direction (sub-scanning direction).

Each of the print heads 12K, 12C, 12M and 12Y is constituted by a line head in which a plurality of ink ejection orifices (nozzles) are arranged through a length exceeding at least one side of the maximum size recording paper 16 intended for use with the inkjet recording apparatus 10.

The print heads 12K, 12C, 12M, 12Y corresponding to respective ink colors are disposed in the order, black (K), cyan (C), magenta (M) and yellow (Y), from the upstream side (the left-hand side in FIG. 1), following the direction of conveyance of the recording paper 16 (the paper conveyance direction). A color print can be formed on the recording paper 16 by ejecting the inks from the print heads 12K, 12C, 12M, and 12Y, respectively, onto the recording paper 16 while conveying the recording paper 16.

The print unit 12, in which the full-line heads covering the entire width of the paper are thus provided for the respective ink colors, can record an image over the entire surface of the recording paper 16 by performing the action of moving the recording paper 16 and the print unit 12 relatively to each other in the paper conveyance direction (sub-scanning direction) just once (in other words, by means of a single sub-scan). Higher-speed printing is thereby made possible and productivity can be improved in comparison with a shuttle type head configuration in which a print head moves reciprocally in a direction (main scanning direction) which is perpendicular to the paper conveyance direction.

Here, the terms main scanning direction and sub-scanning direction are used in the following senses. More specifically, in a full-line head comprising rows of nozzles that have a length corresponding to the entire width of the recording paper, “main scanning” is defined as printing one line (a line formed of a row of dots, or a line formed of a plurality of rows of dots) in the breadthways direction of the recording paper (the direction perpendicular to the conveyance direction of the recording paper) by driving the nozzles in one of the following ways: (1) simultaneously driving all the nozzles; (2) sequentially driving the nozzles from one side toward the other; and (3) dividing the nozzles into blocks and sequentially driving the blocks of the nozzles from one side toward the other. The direction indicated by one line recorded by a main scanning action (the lengthwise direction of the band-shaped region thus recorded) is called the “main scanning direction”.

On the other hand, “sub-scanning” is defined as to repeatedly perform printing of one line (a line formed of a row of dots, or a line formed of a plurality of rows of dots) formed by the main scanning, while moving the full-line head and the recording paper relatively to each other. The direction in which sub-scanning is performed is called the sub-scanning direction. Consequently, the conveyance direction of the reference point is the sub-scanning direction and the direction perpendicular to same is called the main scanning direction.

Although the configuration with the KCMY four standard colors is described in the present embodiment, combinations of the ink colors and the number of colors are not limited to those. Light inks or dark inks can be added as required. For example, a configuration is possible in which print heads for ejecting light-colored inks such as light cyan and light magenta are added.

As shown in FIG. 1, the ink storing and loading unit 14 has ink tanks for storing the inks of the colors corresponding to the respective print heads 12K, 12C, 12M, and 12Y, and the respective tanks are connected to the print heads 12K, 12C, 12M, and 12Y by means of channels (not shown). The ink storing and loading unit 14 has a warning device (for example, a display device or an alarm sound generator) for warning when the remaining amount of any ink is low, and has a mechanism for preventing loading errors among the colors.

The print determination unit 24 has an image sensor (line sensor) for capturing an image of the ink-droplet deposition result of the printing unit 12, and functions as a device to check for ejection defects such as clogs of the nozzles in the printing unit 12 from the ink-droplet deposition results evaluated by the image sensor.

The print determination unit 24 of the present embodiment is configured with at least a line sensor having rows of photoelectric transducing elements with a width that is greater than the ink-droplet ejection width (image recording width) of the print heads 12K, 12C, 12M, and 12Y. This line sensor has a color separation line CCD sensor including a red (R) sensor row composed of photoelectric transducing elements (pixels) arranged in a line provided with an R filter, a green (G) sensor row with a G filter, and a blue (B) sensor row with a B filter. Instead of the line sensor, it is possible to use an area sensor composed of photoelectric transducing elements which are arranged two-dimensionally.

The print determination unit 24 reads a test pattern image printed by the print heads 12K, 12C, 12M, and 12Y for the respective colors, and the ejection of each head is determined. The ejection determination includes the presence of the ejection, measurement of the dot size, and measurement of the dot deposition position.

A post-drying unit 42 is disposed following the print determination unit 24. The post-drying unit 42 is a device to dry the printed image surface, and includes a heating fan, for example. It is preferable to avoid contact with the printed surface until the printed ink dries, and a device that blows heated air onto the printed surface is preferable.

In cases in which printing is performed with dye-based ink on porous paper, blocking the pores of the paper by the application of pressure prevents the ink from coming contact with ozone and other substance that cause dye molecules to break down, and has the effect of increasing the durability of the print.

A heating/pressurizing unit 44 is disposed following the post-drying unit 42. The heating/pressurizing unit 44 is a device to control the glossiness of the image surface, and the image surface is pressed with a pressure roller 45 having a predetermined uneven surface shape while the image surface is heated, and the uneven shape is transferred to the image surface.

The printed matter generated in this manner is outputted from the paper output unit 26. The target print (i.e., the result of printing the target image) and the test print are preferably outputted separately. In the inkjet recording apparatus 10, a sorting device (not shown) is provided for switching the outputting pathways in order to sort the printed matter with the target print and the printed matter with the test print, and to send them to paper output units 26A and 26B, respectively. When the target print and the test print are simultaneously formed in parallel on the same large sheet of paper, the test print portion is cut and separated by a cutter (second cutter) 48. The cutter 48 is disposed directly in front of the paper output unit 26, and is used for cutting the test print portion from the target print portion when a test print has been performed in the blank portion of the target print. The structure of the cutter 48 is the same as the first cutter 28 described above, and has a stationary blade 48A and a round blade 48B.

Moreover, although omitted from the drawing, a sorter for collating and stacking the images according to job orders is provided in the paper output section 26A corresponding to the main images.

Next, the arrangement of nozzles (liquid ejection orifices) in the print head (liquid ejection head) will be described. The print heads 12K, 12C, 12M and 12Y provided for the respective ink colors each have the same structure, and a print head forming a representative embodiment of these print heads is indicated by the reference numeral 50. FIG. 3 shows a plan view perspective diagram of the print head 50.

As shown in FIG. 3, the print head 50 according to the present embodiment achieves a high density arrangement of nozzles 51 by using a two-dimensional staggered matrix array of pressure chamber units 54, each constituted by the nozzle 51 for ejecting ink as ink droplets, a pressure chamber 52 for applying pressure to the ink in order to eject the ink, and an ink supply port 53 for supplying the ink to the pressure chamber 52 from a common liquid chamber (not shown in FIG. 3).

In the embodiment shown in FIG. 3, the pressure chambers 52 each have an approximately square planar shape when viewed from above; however, the planar shape of the pressure chambers 52 is not limited to a square shape. As shown in FIG. 3, the nozzle 51 is formed at one end of a diagonal of each pressure chamber 52, and the ink supply port 53 is provided at the other end thereof.

Although not shown in the drawings, one long full line head may be constituted by combining a plurality of short heads arranged in a two-dimensional staggered array, in such a manner that the combined length of this plurality of short heads corresponds to the full width of the print medium.

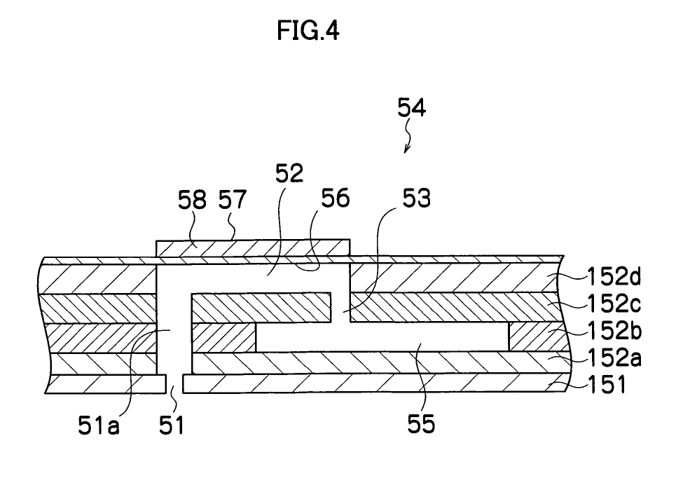

FIG. 4 shows a cross-sectional diagram along line 4-4 in FIG. 3. As shown in FIG. 4, the pressure chamber unit 54 includes the pressure chamber 52 connected to the nozzle 51 ejecting the ink. As well as being connected to the nozzle 51 through a nozzle flow passage 51a, the pressure chamber 52 is also connected to the common liquid chamber 55, which supplies the ink through an ink supply port 53. One surface (in FIG. 4, the ceiling) of the pressure chamber 52 is constituted by a diaphragm 56, and a piezoelectric element 58, which causes the diaphragm 56 to deform by applying a pressure to the diaphragm 56, is bonded on top of the diaphragm 56. An individual electrode 57 is formed on the upper surface of the piezoelectric element 58, and the diaphragm 56 also serves as a common electrode.

As shown in FIG. 4, the pressure chamber units 54 are formed by laminating a nozzle plate 151 formed with the nozzles 51, and various plates 152a, 152b, 152c and 152d formed respectively with the nozzle flow passages 51a, the common liquid chamber 55, the ink supply ports 53, the pressure chambers 52, and the like.

The nozzle 51 is formed by providing a very fine orifice in the nozzle plate 151, and the diameter of the fine orifice may be constant from the top to bottom, as shown in FIG. 4, or the orifice may have a tapered shape in which the diameter narrows from the upper side (pressure chamber side) toward the lower side (ink ejection side).

The piezoelectric element 58 is sandwiched between the common electrode (the diaphragm 56) and the individual electrode 57, and it deforms when a drive voltage is applied between these two electrodes 56 and 57. The diaphragm 56 is pressed by the deformation of the piezoelectric element 58, in such a manner that the volume of the pressure chamber 52 is reduced and the ink is ejected from the nozzle 51. When the voltage applied between the two electrodes 56 and 57 is released, the piezoelectric element 58 returns to its original position, the volume of the pressure chamber 52 returns to its original size, and new ink is supplied into the pressure chamber 52 from the common liquid channel 55 through the supply port 53.

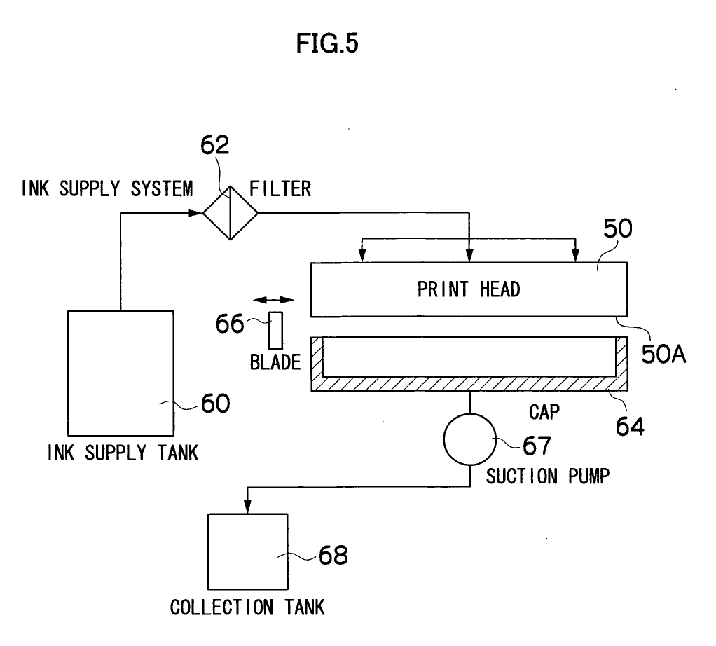

FIG. 5 is a schematic drawing showing the configuration of the ink supply system in the inkjet recording apparatus 10. The ink tank 60 is a base tank that supplies ink to the print head 50 and is set in the ink storing and loading unit 14 described with reference to FIG. 1. The aspects of the ink tank 60 include a refillable type and a cartridge type: when the remaining amount of ink is low, the ink tank 60 of the refillable type is filled with ink through a filling port (not shown) and the ink tank 60 of the cartridge type is replaced with a new one. In order to change the ink type in accordance with the intended application, the cartridge type is suitable, and it is preferable to represent the ink type information with a bar code or the like on the cartridge, and to perform ejection control in accordance with the ink type. The ink tank 60 in FIG. 5 is equivalent to the ink storing and loading unit 14 in FIG. 1 described above.

A filter 62 for removing foreign matters and bubbles is disposed in the middle of the channel connecting the ink tank 60 and the print head 50 as shown in FIG. 5. The filter mesh size in the filter 62 is preferably equivalent to or less than the diameter of the nozzles of the print head 50 and commonly about 20 μm.

Although not shown in FIG. 5, it is preferable to provide a sub-tank integrally to the print head 50 or nearby the print head 50. The sub-tank has a damper function for preventing variation in the internal pressure of the print head 50 and a function for improving refilling of the print head 50.

The inkjet recording apparatus 10 is also provided with a cap 64 as a device to prevent the nozzles from drying out or to prevent an increase in the ink viscosity in the vicinity of the nozzles, and a cleaning blade 66 as a device to clean the nozzle face 50A.

A maintenance unit including the cap 64 and the cleaning blade 66 can be relatively moved with respect to the print head 50 by a movement mechanism (not shown), and is moved from a predetermined holding position to a maintenance position below the print head 50 as required.

The cap 64 is moved upward and downward in a relative fashion with respect to the print head 50 by an elevator mechanism (not shown). When the power of the inkjet recording apparatus 10 is switched off or when the apparatus is in a standby state for printing, the elevator mechanism raises the cap 64 to a predetermined elevated position so as to come into close contact with the print head 50, and the nozzle region of the nozzle surface 50A is thereby covered by the cap 64.

The cleaning blade 66 is composed of rubber or another elastic member, and can slide on the ink ejection surface (nozzle surface 50A) of the print head 50 by means of a blade movement mechanism (not shown). If there are ink droplets or foreign matter adhering to the nozzle surface 50A, then the nozzle surface 50A is wiped by causing the cleaning blade 66 to slide over the nozzle surface 50A, thereby cleaning same.

During printing or during standby, if the use frequency of a particular nozzle 51 has declined and the ink viscosity in the vicinity of the nozzle 51 has increased, then a preliminary ejection is performed toward the cap 64, in order to remove the ink that has degraded as a result of increasing in viscosity.

Also, when bubbles have become intermixed in the ink inside the print head 50 (the ink inside the pressure chambers 52), the cap 64 is placed on the print head 50, the ink in which bubbles have become intermixed inside the pressure chambers 52 is removed by suction with a suction pump 67, and the ink removed by suction is sent to a collection tank 68. This suction operation is also carried out in order to suction and remove degraded ink which has hardened due to increasing in viscosity when the ink is loaded into the print head for the first time, and when the print head starts to be used after having been out of use for a long period of time.

More specifically, when a state in which ink is not ejected from the print head 50 continues for a certain amount of time or longer, the ink solvent in the vicinity of the nozzles 51 evaporates and ink viscosity increases. In such a state, the ink can no longer be ejected from the nozzle 51 even if the actuator (laminated piezoelectric element 58) for the ejection driving is operated. Before reaching such a state (in a viscosity range that allows ejection by the operation of the laminated piezoelectric element 58) the laminated piezoelectric element 58 is operated to perform the preliminary discharge to eject the ink of which viscosity has increased in the vicinity of the nozzle toward the ink receptor. After the nozzle face 50A is cleaned by a wiper such as the cleaning blade 66 provided as the cleaning device for the nozzle face 50A, a preliminary discharge is also carried out in order to prevent the foreign matter from becoming mixed inside the nozzles 51 by the wiper sliding operation. The preliminary discharge is also referred to as “dummy discharge”, “purge”, “liquid discharge”, and so on.

When bubbles have become intermixed in the nozzle 51 or the pressure chamber 52, or when the ink viscosity inside the nozzle 51 has increased over a certain level, ink can no longer be ejected by the preliminary discharge, and a suctioning action is carried out as follows.

More specifically, when bubbles have become intermixed into the ink inside the nozzle 51 and the pressure chamber 52, or when the viscosity of the ink in the nozzle 51 has increased to a certain level or more, the ink can no longer be ejected from the nozzles 51 if the laminated piezoelectric element 58 is operated. In a case of this kind, the cap 64 is placed on the nozzle surface 50A of the print head 50, and the ink containing air bubbles or the ink of increased viscosity inside the pressure chambers 52 is suctioned by the pump 67.

However, since this suction action is performed with respect to all the ink in the pressure chambers 52, the amount of ink consumption is considerable. Therefore, a preferred aspect is one in which a preliminary discharge is performed when the increase in the viscosity of the ink is small. The cap 64 shown in FIG. 5 functions as a suctioning device and it may also function as an ink receptacle for preliminary ejection.

Moreover, desirably, the inside of the cap 64 is divided by means of partitions into a plurality of areas corresponding to the nozzle rows, thereby achieving a composition in which suction can be performed selectively in each of the demarcated areas, by means of a selector, or the like.

FIG. 6 is a principal block diagram showing the system configuration of the inkjet recording apparatus 10. The inkjet recording apparatus 10 comprises a communication interface 70, a system controller 72, an image memory 74, a motor driver 76, a heater driver 78, a print controller 80, an image buffer memory 82, a head driver 84, and the like.

The communication interface 70 is an interface unit for receiving image data sent from a host computer 86. A serial interface such as USB, IEEE1394, Ethernet, wireless network, or a parallel interface such as a Centronics interface may be used as the communication interface 70. A buffer memory (not shown) may be mounted in this portion in order to increase the communication speed. The image data sent from the host computer 86 is received by the inkjet recording apparatus 10 through the communication interface 70, and is temporarily stored in the image memory 74. The image memory 74 is a storage device for temporarily storing images inputted through the communication interface 70, and data is written and read to and from the image memory 74 through the system controller 72. The image memory 74 is not limited to a memory composed of semiconductor elements, and a hard disk drive or another magnetic medium may be used.

The system controller 72 is a control unit for controlling the various sections, such as the communication interface 70, the image memory 74, the motor driver 76, the heater driver 78, and the like. The system controller 72 is constituted by a central processing unit (CPU) and peripheral circuits thereof, and the like, and in addition to controlling communications with the host computer 86 and controlling reading and writing from and to the image memory 74, or the like, it also generates a control signal for controlling the motor 88 of the conveyance system and the heater 89.

The motor driver (drive circuit) 76 drives the motor 88 in accordance with commands from the system controller 72. The heater driver (drive circuit) 78 drives the heater 89 of the post-drying unit 42 or the like in accordance with commands from the system controller 72.

The print controller 80 has a signal processing function for performing various tasks, compensations, and other types of processing for generating print control signals from the image data stored in the image memory 74 in accordance with commands from the system controller 72 so as to supply the generated print control signals (print data) to the head driver 84. Prescribed signal processing is carried out in the print controller 80, and the ejection amounts and the ejection timings of the ink droplets from the respective print heads 50 are controlled via the head driver 84, on the basis of the print data. By this means, prescribed dot size and dot positions can be achieved.

The print controller 80 is provided with the image buffer memory 82; and image data, parameters, and other data are temporarily stored in the image buffer memory 82 when image data is processed in the print controller 80. The aspect shown in FIG. 6 is one in which the image buffer memory 82 accompanies the print controller 80; however, the image memory 74 may also serve as the image buffer memory 82. Also possible is an aspect in which the print controller 80 and the system controller 72 are integrated to form a single processor.

The head driver 84 drives the actuators 58 of the print heads 50 of the respective colors on the basis of print data supplied by the print controller 80. The head driver 84 can be provided with a feedback control system for maintaining constant drive conditions for the print heads.

The print determination unit 24 is a block that includes the line sensor (not shown) as described above with reference to FIG. 1, reads the image printed on the recording paper 16, determines the print conditions (presence of the ejection, variation in the dot formation, and the like) by performing required signal processing, or the like, and provides the determination results of the print conditions to the print controller 80.

According to requirements, the print controller 80 makes various corrections with respect to the print heads 50 on the basis of information obtained from the print determination unit 24.

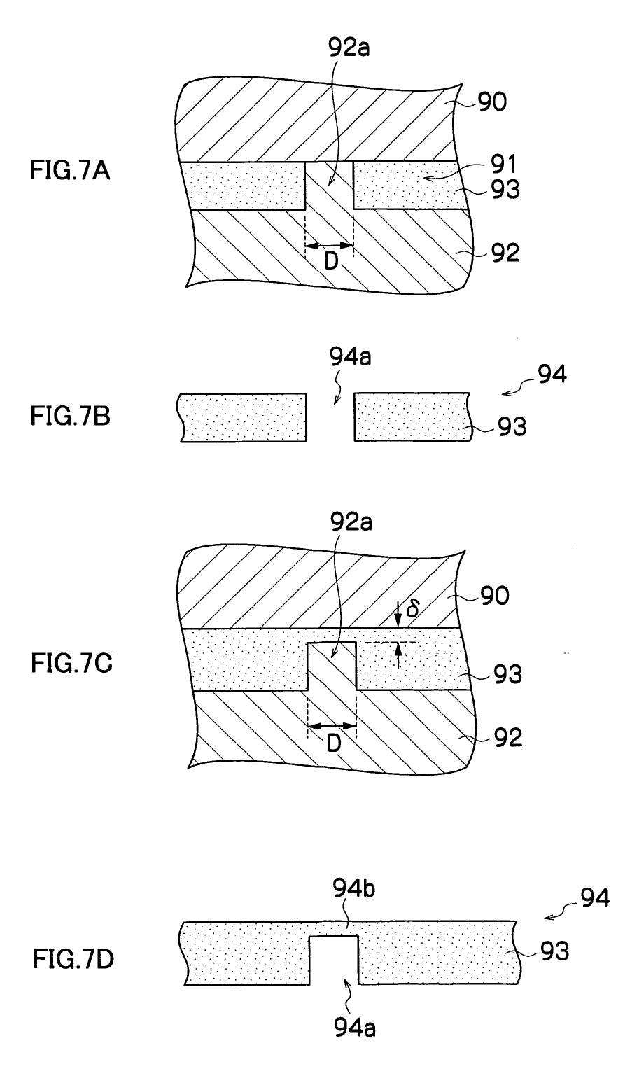

Next, a description is given of the method of forming nozzles 51, which are created by resin molding as fine orifices in the nozzle plate 151 shown in FIG. 4. FIGS. 7A to 7D show a general method for forming fine orifices in a plate by resin molding.

Generally, when forming a product by resin molding, molten resin 93 is injected into a cavity 91 between an upper mold 90 and a lower mold 92 as shown in FIG. 7A, the resin 93 is solidified and then extracted from the molds, and a resin molding 94 as shown in FIG. 7B is thereby obtained.

In this case, the lower mold 92 is provided with circular cylindrical projections (ribs) 92a such as those shown in FIG. 7A, for example, so that orifices 94a are formed in the resin molding 94 in positions corresponding to the projections 92a, as shown in FIG. 7B. In order to form fine orifices such as the nozzles 51, the diameter D of the circular cylindrical projections 92a in the lower mold 92 must be reduced and the projections 92a must be made very fine, like pins. However, when the diameter D of the projections 92a is reduced, the strength of the projections 92a declines. Hence, if the projections 92a directly abut against the upper mold 90 as shown in FIG. 7A when the upper mold 90 and the lower mold 92 are closed together, then there is a risk that the projections 92a may bend or break.

It can be then envisaged that the projections 92a and the upper mold 90 can be prevented from directly abutting against each other, by providing a clearance 6 in such a manner that there is an interval between the upper mold 90 and each of the tips of the projections 92a, even when the upper mold 90 and the lower mold 92 are opposed or closed together, as shown in FIG. 7C. However, in this case, the molten resin 93 also flows into the space formed by the clearance δ, and the holes 94a in the finished resin molding 94 are thereby topped by a thin film of burr 94b, as shown in FIG. 7D, and this thin film of burr 94b must be subsequently removed by means of a blasting process, for example.

Furthermore, on the other hand, when forming a print head 50 by resin molding, sufficient strength cannot be achieved in the structural body of the print head 50 if it is made of resin alone, since resin is extremely weak. For example, if the pressure chambers 52 of the print head 50 are formed by a resin having properties of approximately several gigapascals (GPa) measured with Young's modulus, such as a generic thermoplastic or thermosetting resin, then it is not possible to achieve normal ejection, due to the occurrence of vibration when pressure is applied by the piezoelectric elements 58.

Hence, the material for the pressure chambers 52 desirably has properties whereby deformation does not readily occur in the pressure chambers 52 when applied with pressure by the piezoelectric elements 58; more specifically, the material desirably has properties of 10 GPa or above, when converted to Young's modulus.

If a print head 50 is to be made by resin molding, while taking account of the above-described material properties suitable for the print head 50, then it can be envisaged that the Young's modulus of the structural body could be raised by incorporating micro-particles having a high Young's modulus into the molding resin. In International Application Publication No. WO 02/02697 described above, powder of organic resin, such as epoxy resin, phenol resin, polyester resin, or the like, is considered as micro-particles to be added as a filler to molding resin; however, since the Young's modulus of these materials is around several gigapascals, it is not possible to raise the Young's modulus of the molding by increasing the content of these materials, and hence sufficient strength cannot be achieved in the pressure chambers 52 of the print head 50.

Therefore, in the embodiments of the present invention, in order to raise the Young's modulus of the molding, inorganic micro-particles having a high Young's modulus are added as a filler. Moreover, in order to eject ink of high viscosity, it is necessary to generate even greater pressure in the pressure chambers 52, and the pressure chambers 52 then require even greater strength.

For example, in order to eject high-viscosity ink having the viscosity of 10 cP or above, it is necessary to make the molding have the Young's modulus of 20 GPa or above, a high Young's modulus value is then required in the filler, and the molding is hence made of a thermosetting epoxy resin including 70% or more of micro-particles of inorganic material, such as silica (having Young's modulus of 70 GPa) or alumina (having Young's modulus of 390 GPa).

Viewed in terms of the thermal expansion of the material, a resin material having a low coefficient of linear expansion is desirable, in view of component accuracy and print quality. For example, if an ejection device is composed of a molded component and a stainless steel component, then it is necessary to make the coefficient of linear expansion of the molded component similar to the coefficient of linear expansion of the stainless steel component.

The coefficient of linear expansion of stainless steel is 1.2×10⁻⁵/° C., whereas the coefficient of linear expansion of thermosetting resin and thermoplastic resin is a higher figure of 5×10⁻⁵/° C. to 1×10⁻⁴/° C. If these resin materials are used in combination with a stainless steel component, then there will be a concern regarding the occurrence of warping with temperature change in the structural body, and the like, due to the difference in coefficient of linear expansion.

Therefore, it is thought that warping of this kind in the structural body can be prevented by making the resin molding have a coefficient of linear expansion similar to that of stainless steel. For example, it is possible to achieve a coefficient of linear expansion similar to that of stainless steel, by adding inorganic micro-particles of silica (having coefficient of linear expansion of 3×10⁻⁶/° C.) or alumina (having coefficient of linear expansion of 7×10⁻⁷/° C.) to the resin material, as a filler, and by appropriately adjusting the content of the micro-particles.

In one embodiment, when using a thermosetting epoxy resin and silica micro-particles, it is possible to achieve a coefficient of linear expansion similar to that of stainless steel by incorporating 80% to 90% content of the silica micro-particles. In a case where organic micro-particles are used as a filler added to the resin, since the organic micro-particles have high coefficient of linear expansion, it is then difficult to obtain a coefficient of linear expansion similar to that of a metal.

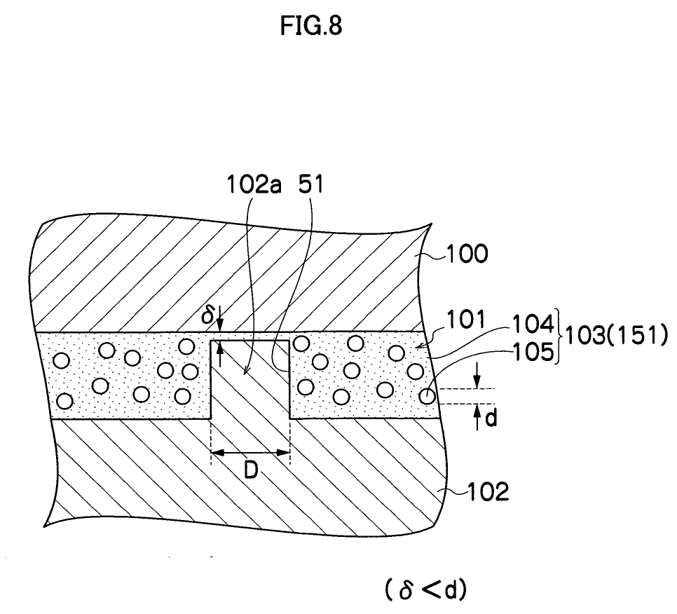

FIG. 8 shows a method of manufacturing nozzles (liquid ejection orifices) according to an embodiment of the present invention.

As shown in FIG. 8, the nozzle plate 151 having nozzles 51 is formed by injecting molten resin material 103 into a cavity 101 formed when an upper mold 100 and a lower mold 102 are closed. In the embodiment shown in FIG. 8, the portions corresponding to the circular cylindrical ribs (pins) 102a provided in the lower mold 102 form the nozzles 51.

As described previously, since the pins 102a for forming the nozzles 51 have a fine diameter D of 20 μm to 30 μm, for example, then a clearance δ of approximately several micrometers (μm) is provided between the upper mold 100 and each of the tips of the pins 102a, in such a manner that the pins 102a are not damaged when the upper mold 100 and the lower mold 102 are opposed.

The resin material 103 to be injected includes 10 wt % to 50 wt % of a thermosetting resin 104 and 50 wt % to 90 wt % of inorganic micro-particles 105 having the Young's modulus of not less than 50 GPa and the coefficient of linear expansion of not more than 5×10⁻⁶/° C. as a filler.

For example, inorganic micro-particles having the average particle size of 10 μm are included in the thermosetting resin 104 having the basic composition of epoxy resin in order to increase rigidity, and the content of epoxy resin is desirably 10 wt % to 25 wt % and the content of inorganic micro-particles is desirably 75 wt % to 90 wt %, so that the rate of contraction upon solidification is 1% or less and excellent mechanical strength is achieved. Moreover, since the resin having such composition has high fluidity and is excellently impressed with fine structures, then the resin is suitable for forming very fine structures. Furthermore, the resin having such composition has low water content and excellent insulating properties, and since the resin has a low coefficient of linear expansion and a small difference from metal in this respect, then distortion due to difference in the coefficient of linear expansion is extremely slight, even when the resin is used in combination with a metal nozzle plate.

The inorganic micro-particles 105 have a diameter d that is greater than the clearance δ, in such a manner that the inorganic micro-particles 105 do not flow into the gap between the pins 102a and the upper mold 100. In other words, δ<d. The clearance 6 between the front ends of the pins 102a of the nozzle forming parts of the lower mold 102 and the upper mold 100 opposing same is thus set to a smaller distance than the diameter d of the filler particles (the inorganic micro-particles 105) incorporated in the resin material 103 to be injected, and it is hence possible to form the nozzles 51 in such a manner that no filler enters into the molding in the nozzle opening parts.

In this way, the thermosetting resin 104 including the inorganic micro-particles 105 as the filler is injected between the upper mold 100 and the lower mold 102, in such a manner that the inorganic micro-particles 105 do not enter into the clearance δ in the nozzle forming parts, and the resin is set by heating, thereby creating the nozzle plate 151.

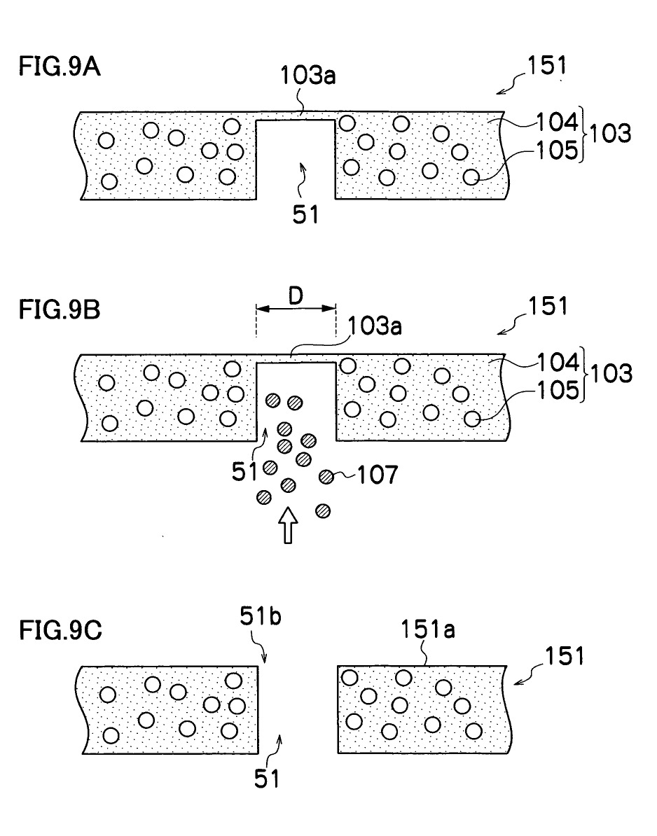

FIG. 9A shows the nozzle plate 151 when removed from the molds after the resin has been set. At the stage of removal from the molds, since the resin that has flowed into the clearance δ forms a thin film of burr 103a in the region of the nozzles 51 of the nozzle plate 151, then it is necessary to remove this burr.

Therefore, as shown in FIG. 9B, the thin film of burr 103a is removed by a blasting process, which involves blowing micro-particles 107, such as beads or silica of smaller size than the nozzle diameter D, onto the thin film of burr 103a. In this case, the micro-particles 107 performing the blasting process are blown onto the nozzle parts 51 of the nozzle plate 151 from the side on which the thin film of burr 103a is not formed (the open sides of the nozzle parts). Since the filler particles (the inorganic micro-particles 105) are not filled in the part of the thin film burr 103a, the burr can readily be processed mechanically, and a high-quality processed face can be achieved.

It is also possible to remove the thin film of burr 103a by blowing a fluid such as water or air at high pressure, rather than the micro-particles such as beads or silica.

As shown in FIG. 9C, the nozzle plate 151 formed with through holes that are to be nozzles 51 is thereby obtained. The nozzle plate 151 uses the side 51b where the thin film of burr 103a was formed on the nozzles 51 as the ink meniscus side (ink ejection side), and a liquid-repelling coating is formed on a nozzle plate surface 151a apart from the area of the nozzles 51.

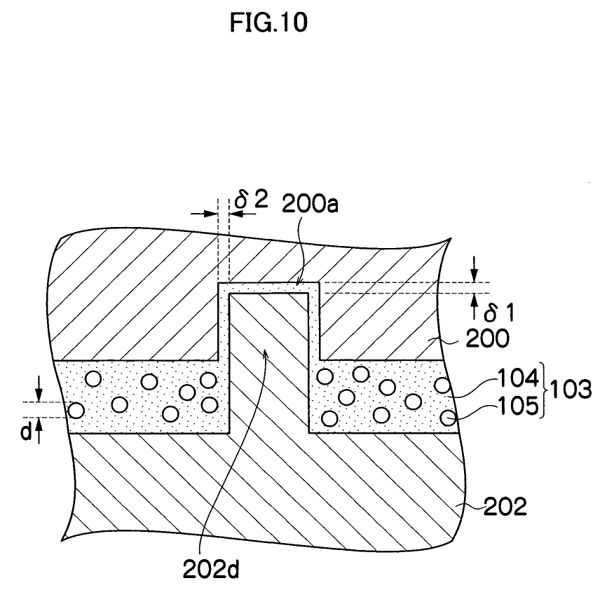

FIG. 10 shows a method of manufacturing nozzles according to a second embodiment of the present invention. In the present embodiment, the step of removing the thin film of burr is made easier by forming the thin film of burr on the nozzle forming parts into a projecting shape as shown in FIG. 10.

For this purpose, the pins 202a in the lower mold 202, which correspond to the nozzle forming parts, are made higher than in the first embodiment described above, and recess parts 200a corresponding to the shape of the pins 202a are provided in the upper mold 200. Similarly to the first embodiment, clearance gaps of δ1 and δ2 are provided respectively on the upper surfaces and the side faces of the pins 202a, between the head parts of the pins 202a and the recess parts 200a of the upper mold 200.

The resin material 103 is injected between the upper mold 200 and the lower mold 202. Similarly to the first embodiment, this resin material 103 is the thermosetting resin including 10 wt % to 50 wt % of the thermosetting resin 104 and 50 wt % to 90 wt % of the inorganic micro-particles 105 having the Young's modulus of not less than 50 GPa and the coefficient of linear expansion of not more than 5×10⁻⁶/° C. as the filler.

Moreover, in this case also, the clearances 61 and 62 are set to be smaller than the diameter d of the inorganic micro-particles 105, in such a manner that the inorganic micro-particles 105 do not enter into the gaps between the pins 202a and the recess parts 200a. More specifically, the relationships δ1<d and δ2<d are established.

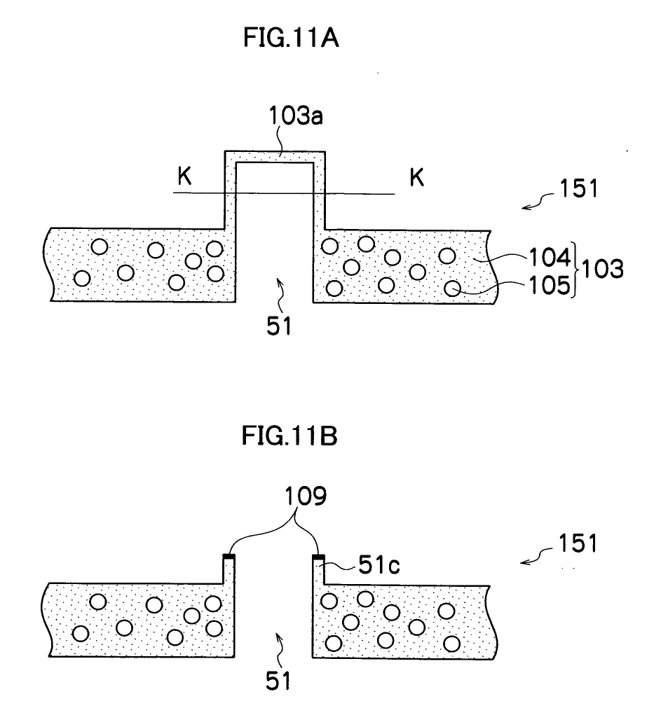

The resin material 103 is injected between the upper mold 200 and the lower mold 202, and is applied with heat, thereby curing the resin, whereupon the resin is released from the molds to obtain the nozzle plate 151, which has a thin film of burr 103a having a projecting shape in the nozzle forming parts, as shown in FIG. 11A. In this case, since the clearances δ1 and δ2 are smaller than the diameter d of the inorganic micro-particles 105, then no inorganic micro-particles 105 are present in the projection-shaped thin film of burr 103a.

Thereupon, the projection-shaped thin film of burr 103a is cut or ground along line K-K shown in FIG. 11A, to form the nozzles 51, which are through holes in the nozzles plate 151, as shown in FIG. 11B. In this case, by taking the side on which the thin film of burr 103a is formed as the ink meniscus side (ink ejection side), and cutting along the line K-K that is slightly distanced from the surface of the basis material of the nozzle plate 151, nozzle edges 51c for clipping the ink meniscus are formed at the end portions of the nozzles 51.

Since the material is cut at a position slightly distanced from the surface of the nozzle plate 151 in this way, the resin cutting properties are improved and the nozzle forming step can be performed readily by means of a cutting tool. Furthermore, since no inorganic micro-particles 105 are introduced in the thin film of burr 103a as described above, then processing can be performed readily and nozzle edge processing of high quality can be achieved.

Moreover, as shown in FIG. 11B, since nozzle edges 51c are formed at positions higher than the surface of the nozzle plate 151, then the nozzle surface does not lie in the same plane as the surface of the nozzle plate 151, and hence ink soiling of the planar part of the structural body is reduced and maintenance characteristics can be improved.

Furthermore, as shown in FIG. 11B, it is possible to limit the liquid repelling surface to the circular faces of the nozzles 51 by coating only the upper surface of the nozzle edges 51c with a liquid repelling agent 109, so that the amount of liquid repelling agent 109 applied is reduced, and costs are hence lowered.

According to the above-described embodiments, strength of the structural body of the nozzle plate is increased by incorporating inorganic micro-particles in the resin forming the structural body, while at the same time, the thin film of burr formed around the nozzle forming parts on the nozzle plate is relatively soft since the inorganic micro-particles are not incorporated into the thin film of burr. Therefore, the thin film of burr around the nozzle forming parts can be removed readily by mechanical processing, while ensuring that suitable strength is obtained in the structural body.

Moreover, by forming the thin film of burr on the nozzle forming parts to especially have a projecting shape, removal of the thin film of burr is facilitated, and it becomes possible to process a plurality of nozzles simultaneously.

It should be understood, however, that there is no intention to limit the invention to the specific forms disclosed, but on the contrary, the invention is to cover all modifications, alternate constructions and equivalents falling within the spirit and scope of the invention as expressed in the appended claims.

What is claimed is:

1. A method of forming a plate having liquid ejection orifices from a thermosetting resin containing inorganic micro-particles, the method comprising the steps of:
opposing a first mold having pins for forming the liquid ejection orifices and a second mold such that a clearance of 6 is provided between the second mold and each of tips of the pins, the clearance δ and a diameter d of the inorganic micro-particles having a relationship of δ<d; and
injecting the thermosetting resin containing the inorganic micro-particles into a cavity between the first and second molds for forming the plate.

2. The method as defined in claim 1, wherein the inorganic micro-particles have a Young's modulus of not less than 50 GPa and a coefficient of linear expansion of not more than 5×10⁻⁶/° C.

3. The method as defined in claim 1, further comprising the step of removing a thin film of burr of the thermosetting resin having been formed on the plate correspondingly to the clearance, by a process of blowing one of fluid and micro-particles.

4. The method as defined in claim 1, wherein the second mold has recess parts corresponding to the pins of the first mold such that a thin film of burr of the thermosetting resin having a projecting shape is formed on a surface of the plate correspondingly to the clearance between the pins of the first mold and the recess parts of the second mold.

5. The method as defined in claim 4, further comprising the step of cutting the thin film of burr having the projecting shape at a position distanced from the surface of the plate for forming an edge of each of the liquid ejection orifices.
